(19) United States
(12) Patent Application Publication
(10) Pub. No.: US 2007/0144553 A1
(43) Pub. Date: Jun. 28, 2007

(54) Tufted multifloss dental article

(76) Inventor: Pamela Jill Hubbard, Longmont, CO (US)

Correspondence Address: RUTH EURE, 4795 EDISON AVENUE, BOULDER, CO, 80301, US

(21) Appl. No.: 11/543,698

(22) Filed: Oct. 4, 2006

Related U.S. Application Data
(60) Provisional application No. 60/753,012, filed on Dec. 22, 2005.

(51) Int. Cl. A61C 15/00

(52) U.S. Cl. 132/321

(57) ABSTRACT

A dental article comprising a primary strand of coated dental floss and accessory fibers of uncoated dental floss attached to the primary strand by overhand knots or other means is provided. The article provides effective cleaning of embrasures of the dentition due to its unique geometry as well as stimulation to the gingival tissue.

### PRIORITY CLAIM

This application claims priority under 35 USC 119(e) to U.S. Provisional patent application 60/753,012, filed Dec. 22, 2005, of common inventorship herewith.

### FIELD OF THE INVENTION

The present invention pertains to the field of dental hygiene, and more specifically to the field of dental floss.

### BACKGROUND

The self cleansing anatomical mechanism provided by the gingival papilla of the dentition is compromised in those suffering from the loss of periodontal support. The resultant loss increases one's risk factors for dental infections by exposing embrasure spaces. This exposure allows for the collection of food debris creating a mechanical irritant as well as a food source to harbor bacterial bibfilm on proximal, often root, tooth surfaces promoting dental disease i.e., dental decay and gingival infection. The difficulty of cleaning proximal tooth surfaces, particularly those of the palatal and lingual aspects is well established. Those surfaces most commonly resemble a rhomboid in the molars, triangular in the bicuspid, to a conical type shape in the incisors, increasing dimension as these surfaces approach the gingival margin. The ability of the average person to manipulate the floss in a wrapping, “C” shape fashion and to vertically maneuver in an apico-occlusal direction to achieve adequate biofilm removal is generally less than fifty percent. This figure is based on observed clinical plaque indices.

A multitude of dental hygiene aids have been devised from specialty fiber flosses, spherical flosses, wedge shaped toothpicks, to interproximal brushes each continuing to leave difficulty in access to these unique surface areas.

Alternatively, persons who exhibit bony overgrowth may also benefit from the use of the tufted multi-floss article of the present invention. In the presence of tori and/or exostosis, particularly in the mandible, an inaccessible void may exist bucco-lingually between the bony plates on enamel surface areas. The depth range of conventional floss is limited by the horizontal “shelf” created by the bony protuberances. With the multi-floss dental article the void can be debrided as the “tuft” is compressed through the contact point between the teeth into the described void and swept from either direction (buccally or lingually).

U.S. Pat. No. 5,842,489 discloses a textured dental floss and a method of making it. The full length of this floss is texturized by having alternating thick and thin regions. Some of the fibers are coated. This contrasts with the instant invention which comprises a coated main strand and several uncoated accessory fibers. Also, an important component of the floss of the instant invention is the knot which is used to attach the accessory fibers to the primary strand.

U.S. Pat. No. 5,063,948 comprises many small pieces (FIG. 12) of floss tied to the “long strand” (FIG. 18) as well as many of these same short pieces (A) tied to the “bristle end”. This is a much more complex system than the “single long strand” and “single short” pieces of the instant invention. Another difference is the type of knot. The “overhand” knot of the present invention allows the user to start out with more “short pieces” as appropriate for molars and pluck out one or two allowing less bulk for smaller spaces in the bicuspid area. Additionally, the present invention combines two different types of floss—one type “coated” for the long strand for easing between the tight contact points and the “fabric” type” floss to maintain bulk as it is swept through the open space (embrasure) below the contact point.

### SUMMARY OF THE INVENTION

The following contains the description of the purpose for and the manner and process for making and using a tufted multi-floss dental article for use in the mechanical, and where prescribed, herbal and chemotherapeutic disinfection of the embrasure spaces of the dentition.

It is an object of the present invention to provide a novel dental article designed to efficiently clean proximal tooth surfaces, particularly those of the palatal and lingual aspects.

It is a further object of the present invention to provide a novel dental floss article which comprises a geometric configuration suitable for cleaning surfaces of embrasures which most commonly describe the shape of a rhomboid in the molars, triangular in the bicuspid, and a conical shape in the incisors, increasing in dimension as these surfaces approach the gingival margin.

It is a further object of the present invention to provide a multi-floss dental article which provides gingival stimulation to the gingival tissue.

It is a further object of the present invention to provide a method for cleaning embrasure spaces of the dentition using the multi-floss dental article of the present invention.

### BRIEF DESCRIPTION OF THE DRAWINGS

FIG. 1 is a view of a completed tufted multi floss article of the present invention.

FIG. 2 is a view of individual elements of the article of the present invention.

FIG. 3 is a side view of a loosened overhand knot used to secure the two elements of the article of the present invention.

FIG. 4 is a side view of a tightened overhand knot.

### DETAILED DESCRIPTION OF THE INVENTION

As used herein the “primary strand” refers to the longer, coated strand of dental floss.

As used herein “accessory fiber” refers to the shorter, uncoated strands of floss which are attached to the primary strand. The accessory fibers comprise self-bulking, noncollapsing multi-component filament or natural fiber type floss.

The primary strand comprises a coated dental floss. Any suitable length is useful, but a length of between 8 and 12 inches, and more specifically a length of approximately 10 inches is suitable. Dental flosses suitable for this purpose include, but are not limited to: Johnson and Johnson™ Waxed Reach™ Dental Floss, Desert Essence™ Tea Tree Oil Waxed Floss, or any other natural or synthetic coated floss. The accessory fibers can be of any appropriate length, but a length of 1 to 3 inches is suitable, and more specifically a length of approximately 2½ inches in length is suitable. The accessory fibers may comprise any self-bulking non-collapsing type multi component filament floss or natural fiber such as Oral B Ultra Floss™, for example. The accessory fibers are attached to the primary strand in a perpendicular configuration to form a “tuft” near one end of the primary strand. This can be accomplished by manually tying an overhand knot or by mechanical means generally used in the manufacturing process of textiles or any other such mechanical means. The overhand knot is most suitable because the tightened knot creates a bump approximating a rhomboid which is preferable for cleaning the embrasures in the dentition.

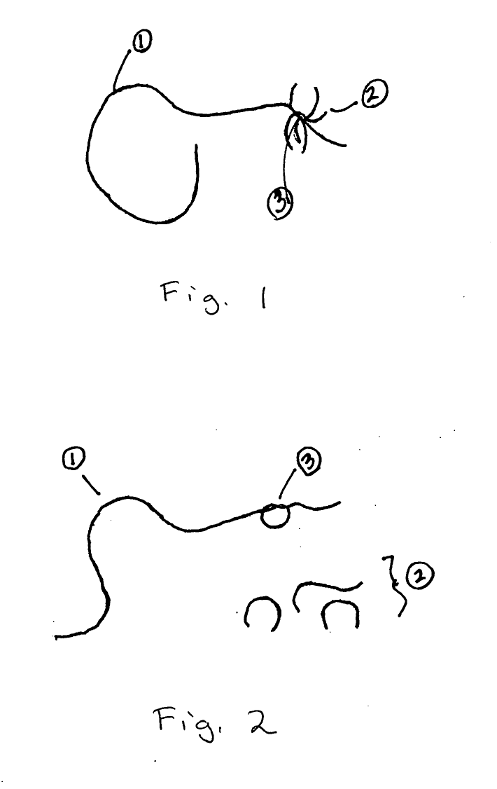

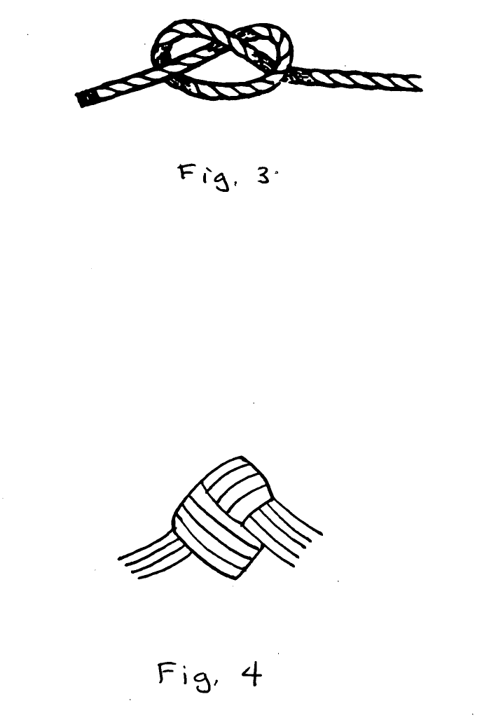

FIG. 1 depicts a view of the completed tufted multi-floss article of the present invention wherein natural or synthetic coated primary strand 1 is approximately 10 inches in length. Multiple accessory fibers 2 approximately 2½ inches in length comprise self-bulking, noncollapsing multi-component filament or natural fiber type floss. Tightened overhand knot 3 secures one or more accessory fibers 2 to coated strand floss 1. Tightened overhand knot 3 also provides the appropriate geometric configuration suitable for cleaning embrasures in the dentition. This geometric configuration can be seen in FIG. 4. FIG. 3 and FIG. 4 are shown with striations so that the direction of the floss can be discerned. The actual floss may not have these striations.

FIG. 2 depicts individual elements of the preferred embodiment of the present invention. Natural or synthetic coated strand floss 1 of approximately 10 inches in length, multiple accessory fibers 2 approximately 2½ inches in length comprising self-bulking, noncollapsing multi-component filament or natural fiber type floss, and open overhand knot 3 to attach accessory fibers 2 to coated strand floss 1.

The manual method of attached accessory fibers 2 to primary strand 1 involves taking a length of primary strand coated floss and tying an open, overhand hand knot approximately 3 inches from one of the ends of the primary strand. The short length accessory fibers 2 can be cut individually, or folded back and forth in a bundle and then cut together. The number of accessory fibers 2 used can be determined by the size of the individual space varying from 1 to more than 10. The desired number of accessory fibers are gathered together and slipped into the open area of the overhand knot 3. The knot 3 is then secured on the coated strand leaving a 1 to 2 inch length to be contained within the bundle of shorter fibers. The resulting appearance simulates a umop” or a “tuft” on the primary strand 1. This type of connection allows the progressive “plucking” of unnecessary short fibers; ie, the larger embrasures are addressed first and the subsequent smaller areas requiring less fibers are then “swept” with the appropriate number of fibers. The various “tuft” sizes can be adjusted by increasing or decreasing the number of accessory fibers used in each knot to accommodate each corresponding interproximal space.

Because contact points between teeth can be troublesome to pass floss through, the coated floss requires a minimum of effort as well as a simple grasp to pass. Many persons find the wrapping of conventional floss tightly around the fingers to achieve enough tension to pass the floss through the teeth is objectionable. With this tufted multi-floss article, the need to wrap around the fingers is not required. Generally, a person can hold the “tufted” end of the floss with the right hand when flossing the left teeth and conversely can hold the “tufted end of the floss with the left hand when flossing the right teeth. The coated floss is held between the fingers on one hand and the tufted end is grasped in the other. Through a gentle back and forth sawing action the coated floss portion of the article is moved between the contact points into the embrasure space. The corresponding right or left hand depending on the side of use is then moved horizontally to ease or “sweep” the “tufted” end completely through the space. As the bulk of “tufts” moves from the lingual/palatal interproximal space out through the facial aspect, the proximal surfaces are completely debrided of soft material and the surrounding gingival area is inadvertently stimulated. This gingival stimulation is a further advantage of the present invention.

Using a highly textured fiber for the accessory fibers comprising the “tufted” end of the flossing article not only provides a mechanical debridement of tooth surfaces, the “tuft” can be used as a highly absorbent material for the introduction of chemotherapeutic agents, including but not limited to Peridex™ brand chlorhexidene gluconate tissue disinfectant, some herbal medicaments such as but not limited to Tooth and Gum Tonic™ or therapeutic oils, for example. These medicaments may be impregnated at the point of manufacture or added by the individual person.

The length of the “passing” strand on the “untufted” end of the primary strand may be manipulated through “closed contact” tooth configurations; whether from natural or manmade consequences. This capability can be accomplished by any “stiffening” method, such as wax, adding a nylon fiber or any rigid filament within the coated stands during a manufacturing process.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. A dental article comprising:
a) a primary strand of dental floss comprising a strand of coated dental floss;
b) at least one accessory fiber comprising a strand of uncoated dental floss;
wherein the accessory fiber is attached to the primary fiber by means which results in said attachment describing essentially a rhomboid shape.

2. The dental article of claim 1 wherein said attachment means is an overhand knot.

3. The dental article of claim 1 wherein the length of the accessory fiber is shorter than the length of the primary strand.

4. The dental article of claim 2 wherein the length of the accessory fiber is shorter than the length of the primary strand.

5. The dental article of claim 1 comprising:
a) a primary strand of dental floss comprising a strand of coated dental floss;
b) a multiplicity of accessory fibers comprising strands of uncoated dental floss;
wherein the attachment means of the accessory fibers to the primary fiber is overhand knots.

6. The dental article of claim 5 wherein the lengths of the accessory fibers are shorter than the length of the primary strand.

7. The dental article of claim 6 wherein the accessory fibers are approximately 1 to 3 inches in length and the primary strand is approximately 8 to 12 inches in length.

8. The dental article of claim 7 wherein the accessory fibers are approximately 1.5 inches in length and the primary strand is approximately 10 inches in length.

9. The dental article of claim 1 comprising:
a) a primary strand of dental floss comprising a strand of coated dental floss;
b) a multiplicity of accessory fibers comprising strands of uncoated dental floss;
wherein the accessory fiber is attached to the primary fiber by means which results in said attachment describing essentially a rhomboid shape.

10. The dental article of claim 9 wherein the lengths of the accessory fibers are shorter than the length of the primary strand.

11. The dental article of claim 9 wherein the accessory fibers are approximately 1 to 3 inches in length and the primary strand is approximately 8 to 12 inches in length.

12. The dental article of claim 9 wherein the accessory fibers are approximately 1.5 inches in length and the primary strand is approximately 10 inches in length.

13. The dental article of claim 3 wherein each accessory fiber is attached to the primary strand with one knot.

14. The dental article of claim 5 wherein a multiplicity of accessory fibers are attached to the primary strand with one knot.

15. The dental article of claim 9 wherein each accessory fiber is attached to the primary strand with one attachment.

16. The dental article of claim 9 wherein a multiplicity of accessory fibers are attached to the primary strand with one attachment.

17. A method of cleaning of cleaning embrasure spaces of the dentition using a dental article comprising:
a) a primary strand of dental floss comprising a strand of coated dental floss having a first end and a second end;
b) a multiplicity of accessory fibers comprising strands of uncoated dental floss;
wherein the accessory fibers are attached to the primary fiber near the first end by any means which provides a rhomboid shape;
wherein the method comprises:
1) holding the article near the first end with the right hand for cleaning embrasure spaces of the dentition of the left side;
2) holding the article near the first end with the left hand for cleaning embrasure spaces of the dentition of the right side;
3) holding the second end of the article with the left hand for cleaning embrasure spaces of the dentition of the left side;
4) holding the second end of the article with the right hand for cleaning embrasure spaces of the dentition of the right side;
5) moving the article between the contact points into the embrasure space of the dentition and making a gentle back and forth sawing action thereby cleaning the embrasure spaces of the dentition.
